(19) United States
(12) Patent Application Publication
(10) Pub. No.: US 2022/0404139 A1
(43) Pub. Date: Dec. 22, 2022

(54) SYSTEM FOR TESTING DISPLACEMENTS OF MULTIPLE LINEAR MOTORS

(71) Applicant: TRIPLE WIN TECHNOLOGY(SHENZHEN) CO.LTD., Shenzhen (CN)

(72) Inventors: WEN-JUN TANG, Shenzhen (CN); YU-TSANG TU, New Taipei (TW); YING-QUAN ZHAO, Shenzhen (CN)

(21) Appl. No.: 17/538,043

(22) Filed: Nov. 30, 2021

(30) Foreign Application Priority Data
Jun. 17, 2021 (CN) 202121346411.8

(51) Int. Cl. G01B 11/02

(52) U.S. Cl. CPC G01B 11/026; H04L 67/12

(57) ABSTRACT

A system for testing linear displacement of multiple linear motors simultaneously under various signals and electrical power supplies includes a testing device, a first processing device, and a second processing device. The first processing device outputs a first start signal to a plurality of first motors to control operation of the plurality of first motors. The second processing device receives a test start signal output by the first processing device, and outputs a first test trigger signal to the test device according to the test start signal. The testing device receives the first test trigger signal, and measures displacements of the moving end of the first motor according to the first test trigger signal.

### TECHNICAL FIELD

The present disclosure relates to field of motor testing, in particular to a motor displacement testing system.

### BACKGROUND

A test system is required for testing motor displacement. Current test system includes test device and processing device, in which the test device and processing device are connected. One processing device is connected to one motor. The processing device is used to output instructions to the test device and the motor respectively, to control the operation of the motor and control the test device to start the displacement test of the motor output terminal. The processing device receives preliminary data output by the test device, and the processing device obtains the final test data through processing of the preliminary test data.

Current test system has a single test channel for motor displacement test. A test device only corresponds to one processing device and one motor, and a test device can only test one motor, the utilization rate of the required hardware is low.

Therefore, improvement is desired.

### BRIEF DESCRIPTION OF THE DRAWINGS

FIG. 1 is a schematic diagram of a motor displacement testing system according to an embodiment of the present disclosure.

FIG. 2 is a schematic diagram of a motor displacement testing system according to another embodiment of the present disclosure.

FIG. 3 is a schematic diagram of a motor displacement testing system according to another embodiment of the present disclosure.

FIG. 4 is a schematic diagram of a motor displacement testing system according to another embodiment of the present disclosure.

FIG. 5 is a schematic diagram of a motor displacement testing system according to another embodiment of the present disclosure.

FIG. 6 is a schematic diagram of a motor displacement testing system according to another embodiment of the present disclosure.

FIG. 7A and FIG. 7B are diagram of relationship regarding position of the motor displacement test according to an embodiment of the present disclosure.

FIG. 8 is a schematic diagram of a motor displacement testing system according to another embodiment of the present disclosure.

### DETAILED DESCRIPTION

The technical solutions in the embodiments of the present disclosure will be described in conjunction with the accompanying drawings in the embodiments of the present disclosure. Obviously, the described embodiments are part of the embodiments of the present disclosure, not all of them. Based on the embodiments of the present disclosure, all other embodiments obtained by those of ordinary skill in the art without creative work shall fall within the protection scope of the present disclosure.

Linear drive motor causes linear displacement as an output. For example, a voice coil motor (VCM) provides linear displacement at the output terminal. After the assembly of linear drive motor, for example the displacement distance and displacement speed of the VCM need to be tested. The displacement test of the motor tests the displacement performance of the motor.

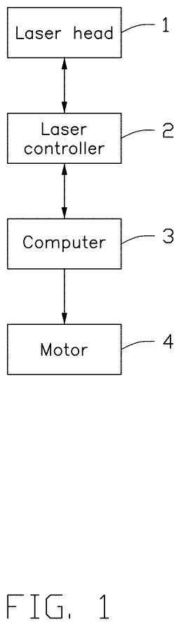

As shown in FIG. 1, a laser head 1 is electrically connected to a laser controller 2, and a computer 3 is electrically connected to a motor 4. The laser head 1, the laser controller 2, the computer 3 and the motor 4 can be electrically connected in turn. The laser head 1 and the laser controller 2 can be used as test devices to test the displacement of a motor 4. The test device used to test the displacement of a motor has a single test channel, resulting in low hardware utilization of the test system.

The embodiment of the present disclosure provides a motor displacement testing system. The motor displacement testing system of the disclosure realizes displacement testing along multiple channels. The testing of multiple motors can be achieved through one testing device, and the cost of the overall testing system is reduced.

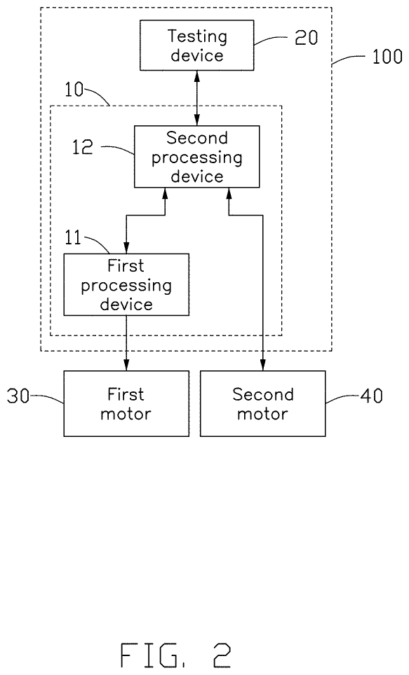

FIG. 2 illustrates a motor displacement testing system 100 in accordance with an embodiment of the present disclosure.

The motor displacement testing system 100 includes a processing device 10 and a testing device 20. The processing device 10 is electrically connected to the testing device 20, the processing device 10 may include a first processing device 11 and a second processing device 12, the second processing device 12 is communicatively connected to the first processing device 11, the second processing device 12 is communicatively connected to the test device 20, the first processing device 11 is electrically connected to a first motor 30, and the second processing device 12 is electrically connected to a second motor 40.

The first motor 30 and the second motor 40 are linear motors requiring linear displacement testing.

The first processing device 11 and the second processing device 12 may be a processor or other electronic devices provided with a processor. For example, in one embodiment, the first processing device 11 and the second processing device 12 can be a computer.

The first processing device 11 and the second processing device 12 can communicate and connect by wires or wirelessly. For example, the first processing device 11 and the second processing device 12 may establish an electrical connection through a connecting cable. The first processing device 11 and the second processing device 12 can establish a wireless communication connection through short-range wireless communication methods (such as BLUETOOTH or WLAN), not being limited in the present disclosure.

In the embodiment, when the first motor 30 performs displacement test, the first processing device 11 can output a first start signal to the first motor 30, and the output of the first motor 30 is linear displacement. When the second motor 40 performs displacement test, the second processing device 12 can output a second start signal to the second motor 40, and the output of the second motor 40 is linear displacement.

When the first motor 30 performs displacement test, when the first processing device 11 outputs the first start signal to the first motor 30, it also outputs the test start signal to the second processing device 12, and the second processing device 12 outputs the first test trigger signal to the testing device 20. The testing device 20 starts to test the displacement of the output terminal of the first motor 30, outputs feedback of the first test to the second processing device 12 at the end of the test, and the second processing device 12 outputs the first test feedback information to the first processing device 11. The first processing device 11 obtains the test result after processing the first test feedback information.

When the second motor 40 performs displacement test, the second processing device 12 outputs the second start signal to the second motor 40 and the second test trigger signal to the testing device 20. The testing device 20 starts to test the displacement of the output of the second motor 40, and outputs feedback of the second test to the second processing device 12 at the end of the test. The second processing device 12 processes the second test feedback information to obtain the test result.

In the embodiment, when the testing device 20 tests the displacement of the output terminals of the first motor 30 and the second motor 40, it measures the change in distance between the testing device 20 and the moving end of the first motor 30, or the distance between the testing device 20 and the moving end of the second motor 40.

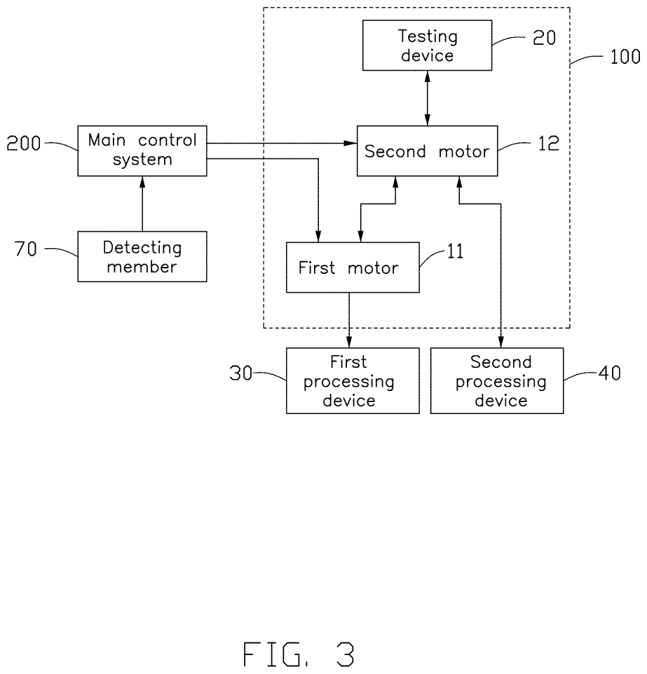

The first processing device 11 and the second processing device 12 can be used to receive the trigger instruction and output the first start signal and the second start signal respectively after receiving the trigger instruction. In one embodiment, the trigger instruction may be issued for manual operation by the operator. In another embodiment, the trigger instruction may also be issued by a main control system 200 (shown in FIG. 3), which can control the operation of the motor.

As shown in FIG. 3, the first motor 30 and the second motor 40 are all created on the same production line (not shown). The production line realizes the whole process control of motor production and testing through the main control system 200. The motor displacement testing system 100 is only a part of the motor production line, which is provided with a test station (not shown) and a transmission device (not shown) for carrying the motor. The test station is provided with a detecting member 70 for detecting whether the motor is moved to the test station, and the detecting member 70 is electrically connected with the main control system 200. The first processing device 11 and the second processing device 12 are electrically connected to the main control system 200. The first motor 30 or the second motor 40 can be moved to the test station in a preset order for testing by the transmission device.

When the first motor 30 or the second motor 40 is moved to the test station, the detecting member 70 detects the presence of first motor 30 or the second motor 40 and outputs a detection signal to the main control system 200. The main control system 200 outputs a test start instruction to the first processing device 11 or the second processing device 12, and the first processing device 11 outputs the first start signal and the test start signal after receiving the test start instruction. The second processing device 12 outputs the first test trigger signal after receiving the test start signal, and the second processing device 12 outputs the second start signal and the second test trigger signal after receiving the test start instruction. The testing device 20 receives the first test trigger signal and the second test trigger signal. Thus, the testing device 20 is controlled to test the first motor 30 or the second motor 40.

After completing a test of the motor, the transmission device transports the next first motor 30 or the next second motor 40 to the test station, and then carries out the testing of the next motor.

In one embodiment, the transmission device may be, but is not limited to, a transmission belt and a turntable.

In one embodiment, the detecting member 70 can be a microswitch or a sensor in a certain position for detection. The types of sensors include but are not limited to infrared sensors and laser sensors.

In the embodiment, the first processing device 11 is electrically connected to the power supply module (not shown) of the first motor 30, and the second processing device 12 is electrically connected to the power supply module (not shown) of the second motor 40. The first processing device 11 can control and record the power supplied to the first motor 30 at a plurality of preset time nodes, and the second processing device 12 can control and record the power supplied to the second motor 40 at a plurality of preset time nodes. The testing device 20 can test and record the displacement of the moving ends of the first motor 30 and the second motor 40 at a plurality of preset time nodes.

The first processing device 11 controls and records the power supplied to the first motor 30 at a preset time node. The second processing device 12 controls and records the power supplied to the second motor 40 at a preset time node. The testing device 20 is a preset time node for testing and recording the displacements achieved by the first motor 30 and the second motor 40. The preset time node mentioned above can be a time point starting from a certain time point or after a preset specified interval.

The content of the first test feedback information may include the displacements of the first motor 30 achieved at each preset time node. The content of the second test feedback information may include the displacements of the second motor 40 achieved at each preset time node. When the first processing device 11 receives the first test feedback information, it can obtain all the displacements of the first motor 30 at each preset time node. When the second processing device 12 receives the second test feedback information, it can obtain all the displacements of the second motor 40 at each preset time node.

The first processing device 11 correlates all the displacements of the first motor 30 at each preset time node to the power and signals supplied to the first motor 30 at each preset time node, the specific displacements of the moving end of the first motor 30 under different electrical inputs can be obtained, and the test result for the first motor 30 can be obtained.

The second processing device 12 correlates all the displacements of the second motor 40 at each preset time node to the power and signals supplied to the second motor 40 at each preset time node, the specific displacements of the moving end of the second motor 40 under different electrical inputs can be obtained, and the test result for the second motor 40 can be obtained.

There may be one or more first processing devices 11 and one or more first motors 30.

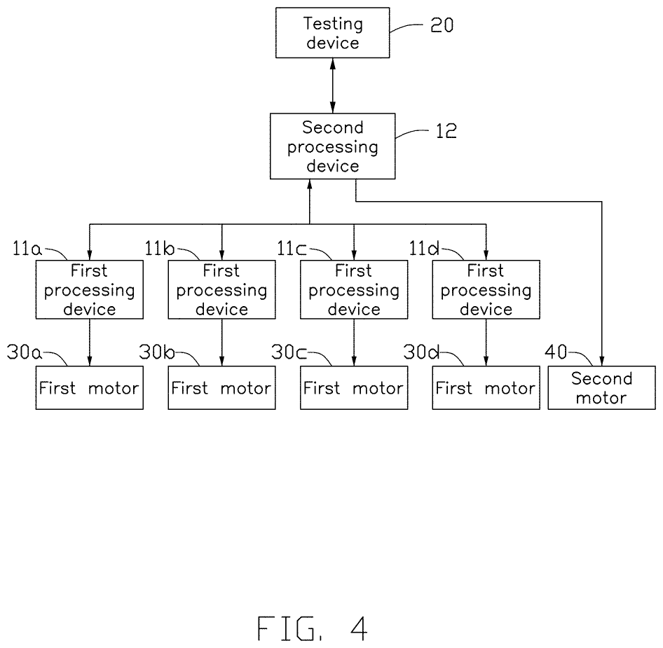

FIG. 4 shows four first processing devices 11a-11d and four first motors 30a-30d as examples.

The four first processing devices 11a-11d are respectively electrically connected with the four first motors 30a-30d. The displacement tests of the second motor 40 and the four first motors 30a-30d can be carried out in turn. The sequence of testing can be as follows: the first motor 30a, the first motor 30b, the second motor 40, the first motor 30c and the first motor 30d.

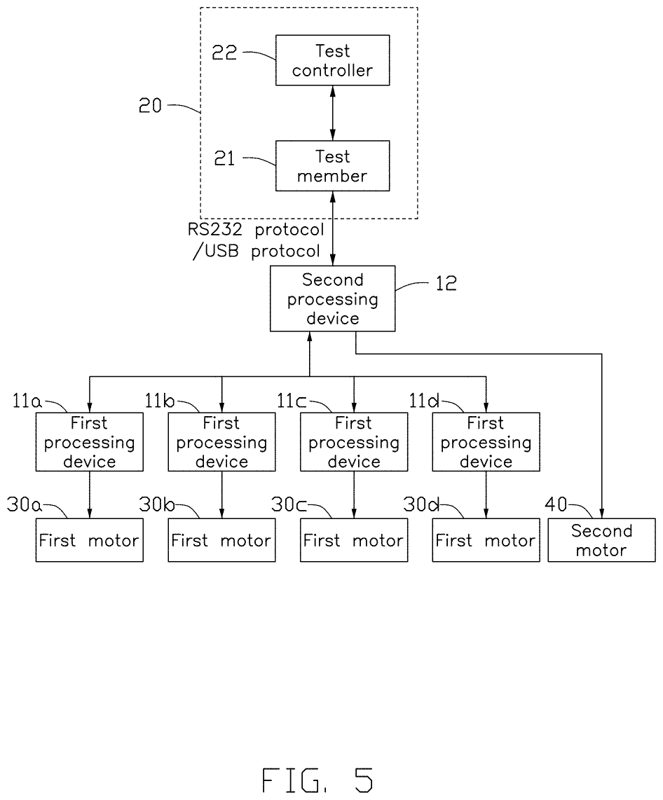

Referring to FIG. 5, in some embodiments, the testing device 20 includes a test controller 21 and a test member 22. The test controller 21 is electrically connected to the test member 22, and the testing controller 21 is communicatively connected to the second processing device 12. The test controller 21 is used to receive the first test trigger signal and output the first test signal to the test member 22 according to the first test trigger signal. After receiving the first test signal, the test member 22 starts to test the displacements of the first motor 30. That is, the displacement of the first motor 30 is tested once at each preset time point. The test controller 21 is also used to receive the second test trigger signal and output the second test signal to the test member 22 according to the second test trigger signal. After receiving the second test signal, the test member 22 starts to test the displacements of the second motor 40, that is, test the displacements of the second motor 40 at each preset time point.

After each test of the first motor 30, the test member 22 outputs a first test information to the test controller 21, which preliminarily processes the first test information. After the test member 22 tests the first motor 30 at all preset time nodes, the test controller 21 outputs the first test feedback information to the second processing device 12 according to the processing result of the first test information. The second processing device 12 then outputs the first test feedback information to the first processing device 11.

After each test of the second motor 40, the test member 22 outputs the second test information to the test controller 21, and the test controller 21 preliminarily processes the second test information. After the test member 22 tests the second motor 40 at all preset time nodes, the test controller 21 outputs the second test feedback information to the second processing device 12 according to the processing result of the second test information.

The preliminary processing of the first test information and the second test information by the test controller 21 includes but is not limited to converting an analog signal into a digital signal.

The test controller 21 and the second processing device 12 may be communicatively connected by wires or wirelessly. For example, the test controller 21 and the second processing device 12 may be electrically connected by a connecting cable. The test controller 21 and the second processing device 12 can establish a wireless communication connection through short-range wireless communication as before.

In one embodiment, the test controller 21 and the second processing device 12 can be electrically connected through the USB protocol serial port, so as to realize the communication connection between the test controller 21 and the second processing device 12.

In another embodiment, the test controller 21 and the second processing device 12 can be electrically connected through the RS-232C protocol serial port, so as to realize the communication connection between the test controller 21 and the second processing device 12.

During the testing, the current supplied to the first motor 30 or the second motor 40 is increased at preset specified intervals, that is, the supply current is increased by a fixed value at each preset time node.

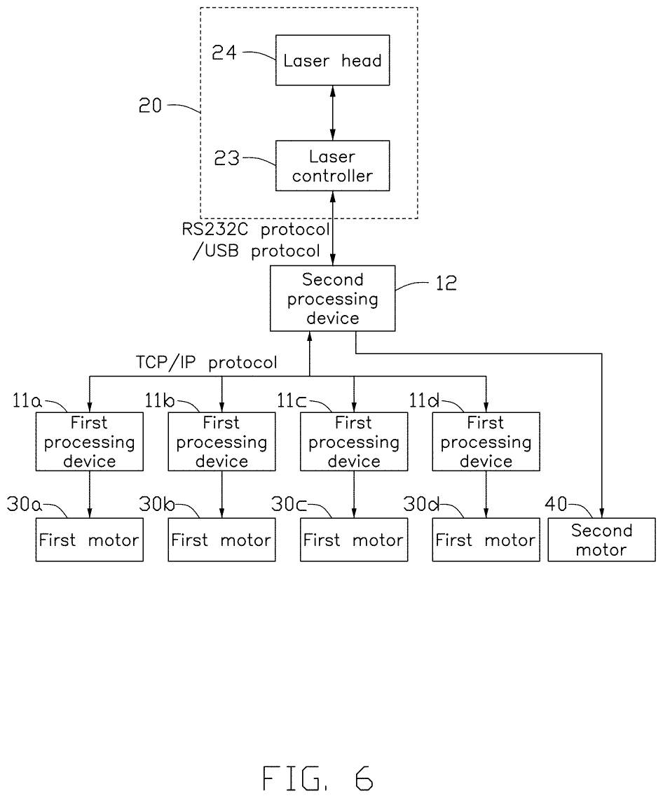

Referring to FIG. 6, in some embodiments, the testing device 20 can test the displacement achieved through the laser reflection ranging principle, the test controller 21 is the laser controller 23, and the test member 22 is the laser head 24.

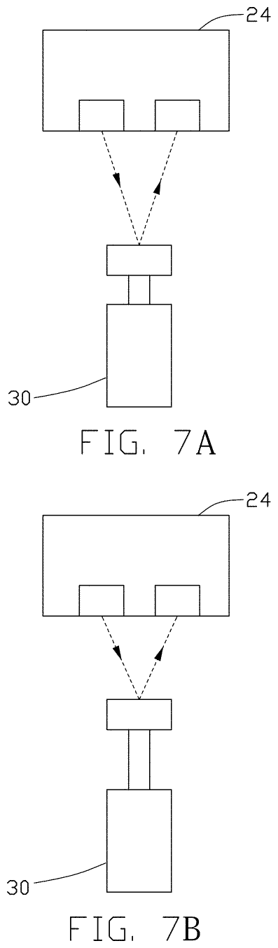

Referring to FIG. 7A and FIG. 7B, when the testing of the first motor 30 is required, the moving end of the first motor 30 is aligned with the laser head 24, and linear movement of the moving end of the first motor 30 will be closer to or further from the laser head 24. When the testing of the second motor 40 is required, the moving end of the second motor 40 is aligned with the laser head 24, for linear movement closer to or further from the laser head 24.

In the embodiment, the laser head 24 includes a laser transmitting portion and a laser receiving portion. Before testing a motor, the laser emitted by the laser transmitting portion of the laser head 24 is emitted to the target motor, and specular reflection and/or diffuse reflection from a surface of the moving end is recorded only when the laser head 24 receives the first test signal or the second test signal. The laser head 24 will test the displacements at each preset time point, and output the test results of each time node to the laser controller 23 in the form of the first test information or the second test information.

For the purposes of testing, a reflector can be arranged on the moving end of the first motor 30 and the second motor 40, so as to increase the reflective surface of the laser and facilitate the reflection of the laser onto the laser receiving portion of the laser head 24.

For example, in some embodiments, the first motor 30 and the second motor 40 are voice coil motors for smartphone camera focusing. At this time, the moving ends of the first motor 30 and the second motor 40 can be provided with lens modules from the smartphone. When testing the first motor 30 and the second motor 40, the lens module is aligned with the laser transmitting portion of the laser head 24, the lens module will act as a reflector to improve the quality of reflection on the laser receiving portion of the laser head 24.

In one embodiment, the second processing device 12 and each first processing device 11 realize communication connection through wired LAN and/or wireless LAN.

In one embodiment, the second processing device 12 is connected to each of the first processing devices 11 through TCP/IP protocol communication.

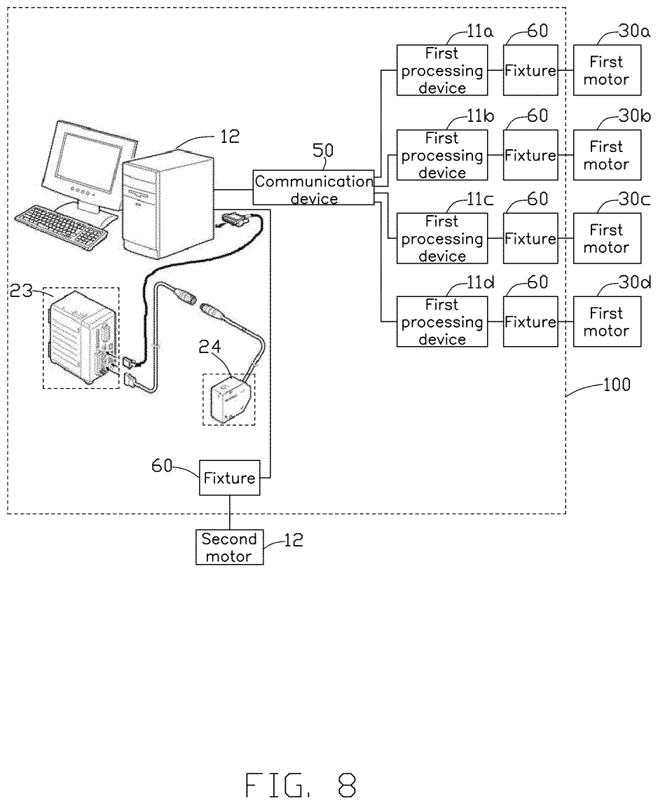

Referring to FIG. 8, in one embodiment, the motor displacement testing system 100 also includes a communication device 50, and the second processing device 12 is connected with a plurality of the first processing devices 11 through the communication device 50. The communication device 50 includes, but is not limited to, a router or a switch.

For example, in some embodiments, the communication device 50 is a router, and the first processing device 11 and the second processing device 12 are electrically connected to the communication device 50 through network cables, to realize the electrical connection between the first processing device 11 and the second processing device 12.

The motor displacement testing system 100 also includes a fixture 60, which is used to provide an installation position for the first motor 30 and the second motor 40 under test. The first motor 30 and the second motor 40 can be respectively electrically connected with different fixtures 60, each first processing device 11 being electrically connected with the fixture 60 and different first motors 30 as required. The second processing device 12 is likewise electrically connected with the fixture 60 and second motors 40.

The electrical connection between the first processing device 11 and the fixture 60 realizes the electrical connection between the first processing device 11 and the first motor 30, and the electrical connection between the second processing device 12 and the fixture 60 realizes the electrical connection between the second processing device 12 and the second motor 40.

The number of fixtures 60 is equal to the sum of first motors and second motors 30 and 40, each fixture 60 provides an installation position for one first motor 30 or one second motor 40.

In the motor displacement testing system 100, the different fixtures 60 may provide installation positions for a single type or different types of motors. The first motor 30 and the second motor 40 may be motors of the same model or motors of different models.

The implementation principle of the motor displacement testing system 100 according to the embodiment of the present disclosure is described below in combination with FIG. 8.

Perform displacement tests on the first motor 30a, the first motor 30b, the second motor 40, the first motor 30C, and the first motor 30d in sequence. First, the first motor 30a is tested for displacement, and the first processing device 11a outputs the first start signal to the first motor 30a through the fixture 60. At this time, the first motor 30a starts to operate under power with increasing current value, and the moving end of the first motor 30a starts to move closer to the laser head 24.

While the first processing device 11a outputs the first start signal, the first processing device 11a outputs the test start signal to the second processing device 12. The second processing device 12 outputs the first test trigger signal to the laser controller 23, and the laser controller 23 outputs the first test signal to the laser head 24. The laser head 24 starts to test displacements of the first motor 30 at a plurality of preset time nodes, and outputs the first test information to the laser controller 23. The laser controller 23 preliminarily processes the first test information. After the laser head 24 completes the testing at all preset time nodes, the laser controller 23 outputs the first test feedback information to the second processing device 12.

The second processing device 12 then outputs the first test feedback information to the first processing device 11a. The first processing device 11a compares the displacements of the first motor 30 at each time node and the power and signals supplied to the first motor 30a at each time node one by one. The total displacements of the first motor 30a under the signals and power supplied at various current values can be obtained, that is, the test result of the first motor 30a can be obtained.

Then, the first motor 30b moves to the position where the original first motor 30a is located. The first processing device 11b outputs the first start signal and the test start signal to the first motor 30b and the second processing device 12 respectively, so as to test displacements of the first motor 30b.

When the second motor 40 is being tested, the second processing device 12 outputs the second start signal and the second test trigger signal to the second motor 40 and the laser controller 23 respectively.

After testing all the displacements of the second motor 40 at a plurality of time nodes, the laser controller 23 outputs the second test feedback information to the second processing device 12. The second processing device 12 compares the total displacement of the output terminal of the second motor 40 at each time node and the power supplied to the second motor 40 at each time node one by one.

The specific total displacements of the second motor 40 under the supplied current of various current values can be obtained, that is, the test result of the second motor 40 can be obtained. Then, the displacement test of the first motor 30C and the first motor 30d can be continued.

Those of ordinary skill in the art will realize that the above embodiments are only used to illustrate the present disclosure, but not to limit the present disclosure. As long as they are within the essential spirit of the present disclosure, the above embodiments and others are appropriate, changes and modifications fall within the scope of protection of the present disclosure.

What is claimed is:

1. A motor displacement testing system applicable for testing displacement of output terminal of a motor, and comprising:
a testing device;
a first processing device adapted for outputting a first start signal to a plurality of first motors to control operation of the plurality of first motors;
a second processing device adapted for receiving a test start signal output by the first processing device, and output a first test trigger signal to the test device according to the test start signal;
wherein the testing device receives the first test trigger signal, and measures a displacement of the output terminal of the first motor according to the first test trigger signal.

2. The motor displacement testing system of claim 1, wherein the second processing device is adapted for outputting a second start signal to the second motor, to control the operation of the second motor; the testing device is further adapted for receiving a second test trigger signal output by the second processing device, and measuring the displacement of the output terminal of the second motor according to the second test trigger signal.

3. The motor displacement testing system of claim 1, wherein a plurality of the first processing devices are respectively connected with a plurality of the first motors one by one.

4. The motor displacement testing system of claim 1, wherein the testing device comprises a test controller and a test member, the test controller is adapted for receiving the first test trigger signal output by the second processing device, and outputting the first test signal to the test member according to the first test trigger signal; the test member is adapted for receiving the first test signal and measuring the displacement of the output terminal of the first motor according to the first test signal.

5. The motor displacement testing system of claim 1, wherein the testing device is adapted for outputting a first test feedback information to the second processing device after completing the test of the first motor; the second processing device is adapted for receiving the first test feedback information, and outputting the first test feedback information to the first processing device, and the first processing device processes test data.

6. The motor displacement testing system of claim 2, wherein the testing device is adapted for outputting a second test feedback information to the second processing device after completing the test of the second motor, and the second processing device processes test data.

7. The motor displacement testing system of claim 1, wherein the second processing device and the testing device are connected through USB protocol or RS232C protocol communication.

8. The motor displacement testing system of claim 1, wherein the first processing device and the second processing device are connected through wireless LAN and/or wired LAN communication.

9. The motor displacement testing system of claim 1, wherein the motor displacement testing system further comprises a communication device, and the second processing device is connected to a plurality of the first processing devices through the communication device.

10. The motor displacement testing system of claim 2, wherein the motor displacement testing system further comprises a plurality of fixtures, the plurality of fixtures are electrically connected to the first processing device and the second processing device for electrical connection with the first motor and the second motor, and the first motor and the second motor are installed on the corresponding fixture.

11. A motor displacement testing system applicable for testing displacement of output terminal of a motor, and comprising:
a testing device;
a first processing device adapted for outputting a first start signal to a plurality of first motors to control operation of the plurality of first motors;
a second processing device adapted for receiving a test start signal output by the first processing device, and output a first test trigger signal to the test device according to the test start signal;
wherein the testing device receives the first test trigger signal, and measures a displacement of the output terminal of the first motor according to the first test trigger signal;
wherein the second processing device is adapted for outputting a second start signal to the second motor, to control the operation of the second motor; the testing device is further adapted for receiving a second test trigger signal output by the second processing device, and measuring the displacement of the output terminal of the second motor according to the second test trigger signal.

12. The motor displacement testing system of claim 11, wherein a plurality of the first processing devices are respectively connected with a plurality of the first motors one by one.

13. The motor displacement testing system of claim 11, wherein the testing device comprises a test controller and a test member, the test controller is adapted for receiving the first test trigger signal output by the second processing device, and outputting the first test signal to the test member according to the first test trigger signal; the test member is adapted for receiving the first test signal and measuring the displacement of the output terminal of the first motor according to the first test signal.

14. The motor displacement testing system of claim 11, wherein the testing device is adapted for outputting a first test feedback information to the second processing device after completing the test of the first motor; the second processing device is adapted for receiving the first test feedback information, and outputting the first test feedback information to the first processing device, and the first processing device processes test data.

15. The motor displacement testing system of claim 11, wherein the testing device is adapted for outputting a second test feedback information to the second processing device after completing the test of the second motor, and the second processing device processes test data.

16. The motor displacement testing system of claim 11, wherein the second processing device and the testing device are connected through USB protocol or RS232C protocol communication.

17. The motor displacement testing system of claim 11, wherein the first processing device and the second processing device are connected through wireless LAN and/or wired LAN communication.

18. The motor displacement testing system of claim 11, wherein the motor displacement testing system further comprises a communication device, and the second processing device is connected to a plurality of the first processing devices through the communication device.

19. The motor displacement testing system of claim 11, wherein the motor displacement testing system further comprises a plurality of fixtures, the plurality of fixtures are electrically connected to the first processing device and the second processing device for electrical connection with the first motor and the second motor, and the first motor and the second motor are installed on the corresponding fixture.
